(19) United States
(12) Patent Application Publication
(10) Pub. No.: US 2015/0165557 A1
(43) Pub. Date: Jun. 18, 2015

(54) APPARATUS AND METHOD FOR REPAIR AND RENOVATION OF CRANKSHAFT JOURNAL SURFACES IN-SITU BY MEANS OF LASER CLADDING

(71) Applicant: Toms Torims, Riga (LV)

(72) Inventor: Toms Torims, Riga (LV)

(21) Appl. No.: 14/406,514

(22) PCT Filed: Jul. 18, 2013
(86) PCT No.: PCT/LV2013/000006

§ 371 Date: Dec. 8, 2014

(30) Foreign Application Priority Data
Aug. 7, 2012 (LV) P-12-130

(51) Int. Cl. B23K 26/34; B23K 37/04; B23P 6/00; B23K 26/08

(52) U.S. Cl. CPC B23K 26/345; B23K 26/0823; B23K 26/0869; B23K 37/0452; B23P 6/00; B23P 2700/07

(57) ABSTRACT

The invention refers to manufacturing engineering, in particular to shipbuilding and ship repair. Said invention applies to internal combustion engines, such as marine diesel engines. The invention relates to an apparatus in above described fields for repair and renovation of the crankshaft journal (bearing) surfaces, by means of laser build-up (cladding). Invented apparatus and method is designed to perform journals build-up (cladding) operations directly in the engine housing, without removing the crank-shaft from the engine.

### FIELD OF THE INVENTION

The field of invention refers to manufacturing engineering, in particular to shipbuilding and ship repair. Said invention applies to internal combustion engines, such as marine diesel engines.

The invention relates to an apparatus in above described fields for repair and renovation of the crankshaft journal (bearing) surfaces, by means of laser build-up (cladding). Invented apparatus and method is designed to perform crankpin journals surfaces build-up (cladding) operations directly in the engine housing, without removing the crankshaft from the engine.

### BACKGROUND OF THE INVENTION

Heavy working conditions and intensive wear of the marine diesel engine crankshaft main and crankpin journals surfaces, accompanied with eventual lubrication failures are causing various damages of the journal surfaces. Common faults in the surface of the journals are: ridges, cuts, grooves, tearings, marks and formation of built-up edge. Wear is causing also loss of required geometrical clearances of the crankshaft journals, such as roundness and alignment to the centre.

The above mentioned damages are also affecting mechanical properties of journal surfaces. This results in reduced hardness and stiffness or in contrary excessive surface hardening. Therefore regular repairs of marine diesel engine crankshaft main and crankpin journals surfaces are needed in order to perform partial or complete renovation of the worn-out crankshaft journals. These repairs are done in the workshop, by removing crankshaft from engine and subsequently performing journal grinding on stationary machines. Crankshaft usually is fixed in the centres and rotated around its central axe.

Where it is necessary also various types of build-up operations are carried out in the specialized on-shore workshops. Subsequently crankshaft journal is machined to the required dimensions as per manufacturers' specifications.

Crankshaft journals can be renovated using various technologies, e.g.: conventional TIG/MIG/MAG build-up welding, plasma coating—welding and spraying. These surface refurbishing techniques are approved by certain Ship Classification Societies, yet are limited to use only within workshop (onshore) environments, are time consuming and can be performed only by highly sophisticated machinery. Other manual operations (e.g. metal-plastics, grinding and lapping) can be applied for emergency repairs and only as a temporary solution.

None of these technologies can be used on board the ship to fully build-up crankshaft crankpin journal surfaces. However, frequently crankshaft crankpin repairs have to be done directly on board of the vessel or even at sea and not in the comfortable conditions of on-shore facilities.

Prior efforts have been made to tackle a problem of in situ repair of crankshaft journals. In article “Torims T, Gerins E., Ratkus A. Shipboard Crankshaft Bearing In-Situ Repairs Utilizing Laser Build-Up Welding//Annals of DAAAM & Proceedings 2011, Austria, Vienna, 23.-26. November, 2011.—pp 597-598” is outlined an idea of laser build-up welding application to the marine engine crankshafts, however, without proposing particular technical solutions.

In article “H. Koehler, K Partes, T. Seefeld, F. Vollertsen. Laser reconditioning of crankshafts: From lab to application. Physics Procedia, Volume 5, Part A, 2010, pp. 387-397.” is described a technique of laser build up on crankshaft. Described technique is limited to the workshop conditions and is not in-situ technological solution.

In article “I. A. Vishnevetskaya, V. A. Denisov and A. V. Solovyov. Tribotechnical efficiency of journal-bearing connection of crankshaft renewed by laser built-up welding. Proc. SPIE 2713, 301, 1996, pp 301-305” is addressed material properties issues and do not give any technical solutions or applications of the laser build-up technology itself.

In-situ crankshaft journal grinder is described in document U.S. Pat. No. 2,937,479. Given apparatus refers to an “on-site” journal correctors or reconditioning devices. Document GB No. 869,240 describes a crankshaft grinder relevant to above mentioned document U.S. Pat. No. 2,937,479. Said apparatuses are limited to the grinding only. Similar technology is described in documents U.S. Pat. No. 3,054,233 and U.S. Pat. No. 3,103,088. Mentioned crankshaft grinders are similar to the previous patents, but now are applicable also to the crankshafts having no filets. In document SU 1311911 is described a device for grinding connecting-rod journal of crankshaft inside engine. All above documents describe apparatuses for in-situ grinding of crankshaft journals.

There is also a document CN No. 101922006 describing process for repairing crankshaft of internal combustion engine by laser cladding or build-up laser technology. Said process refers to a repair of crankshafts which are taken out from the engine and does not proposes a technique for laser cladding of a crankshaft in situ.

After analysing said apparatuses and methods it was discovered that it is impossible to implement laser technologies. There is a need for a totally new approach to implement laser built up technologies in in-situ crankshaft journal repair apparatuses.

### Objective and Summary of the Invention

The aim of invention is to design an apparatus and method for renovation and repair of crankshaft journal surfaces in-situ by means of laser build-up (cladding).

The essence of the invention is an apparatus for repair and renovation of crankshaft journal surfaces. The apparatus comprising two guide-ways and two opposite-guide-ways for positioning said apparatus on crankshafts fillets and two frame parts where each frame part is fixed to respectively guide-way.

Additionally apparatus comprises at least two upper rods by means of which both frame parts are in fixed connection to each other, wherein the upper rods are position in the upper part of the frame part, and at least two lower rods by means of which both frame parts are in fixed connection to each other, wherein the lower rods are position in the lower part of the frame part. Apparatus further comprises two carriages which are installed on the upper rods and lower rods so that both carriages can be slidably moved along said rods. A laser nozzle is installed operatively between both carriages. Apparatus comprises two control motors, wherein a first control motor is installed in the first carriage and operatively connected to the laser nozzle to control its pivoting angle, and a second control motor is installed in the second carriage and operatively connected to the one of the two lower rods by means of a gearing transmission to control a longitudinal position of the laser nozzle.

The gearing transmission of the apparatus comprises a spur gear connected to the second control motor and a toothed rack, which is made directly onto the lower rod.

The first control motor is connected to the laser nozzle through a bush.

To ensure positioning and controlled rotation of the apparatuses around the crankshaft journal, it comprises two above described guide-ways and two opposite-guide-ways. Two supporting plates are permanently fixed on the opposite-guide-ways. Further, these supporting plates are connected to each other by at least two opposite-rods by means of which both opposite-guide-ways are in fixed connection to each other.

When installed on the crankshaft journal, guide-ways and opposite-guide-ways are connected and fixed to each other by means of four adjustable arms. Adjustable arms are connected with guide-ways and opposite-guide-ways by eight guidance-screws.

While crankshaft is being rotated around its main axe, the laser head top-down position is ensured by eight expandable-shrinkable elements (e.g. pneumatic cylinders). These eight expandable-shrinkable elements are connected with the guide-ways and opposite-guide-ways by the aforementioned eight guidance-screws. Expandable-shrinkable elements can freely rotate around these eight guidance-screws.

Further, said expandable-shrinkable elements are connected to the housing of the engine by means of four side-plates. These four side plates in turn are positioned and fixed on the engine housing opening hatches bolts. Additionally expandable-shrinkable elements are connected to the said side-plates by eight guidance-bolts. These expandable-shrinkable elements can freely rotate around these eight guidance-bolts.

The invention also describes a method for repair and renovation of crankshaft journal surfaces using above-mentioned apparatus.

The method includes the steps of:
a) positioning of said apparatus above a damaged (renewable) surface of the journal by means of said guide-ways and opposite-guide-ways;
b) applying a cladding powder onto the damaged surface of the journal;
c) positioning of a laser nozzle above the damaged surface of the journal by means of two control motors;
d) irradiation of the cladding powder by a laser beam emitted from the laser nozzle;
e) repeatedly performing steps b) through d) until the damaged surface of the journal is cladded.

In step c) a pivoting motion of the laser nozzle is performed by means of the first control motor and a longitudinal positioning of the laser nozzle is performed by means of the second control motor and its gearing transmission.

In accordance with the apparatus and method of this invention, the crankshaft does not need to be removed from the engine or motor block in order to repair or renovate the crankshaft journal surfaces.

### BRIEF DESCRIPTION OF DRAWINGS

The invention will be better understood in connection with the accompanying drawings, in which:

FIG. 1 is an isometric view of an apparatus positioned on internal fillets of a crankshaft;

FIG. 2 is an fragmentary view of a crankshaft showing crankshaft external fillets on which said apparatus is positioned by means of guide ways 2;

FIG. 3 is the orthogonal projection of an apparatus positioned on a crankshaft;

FIG. 4 is an isometric view of apparatus for in-situ laser build-up (cladding) positioned on a crankshaft;

FIG. 5 is a cross-sectional view of an apparatus positioned on a crankshaft—upper part;

FIG. 6 is a cross-sectional view of an apparatus positioned on a crankshaft; and

FIG. 7 a cross-sectional view of an apparatus positioned on a crankshaft—lower part

### DETAILED DESCRIPTION OF THE INVENTION

This invention is an apparatus and method for in-situ laser build-up (cladding) of the crankshaft crankpin journals.

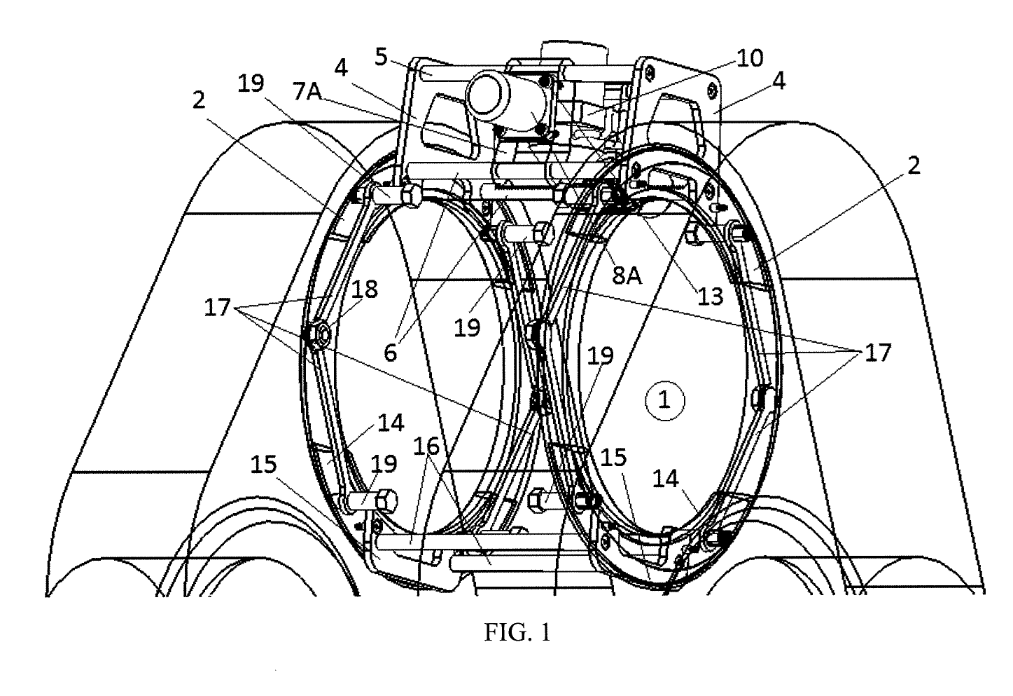

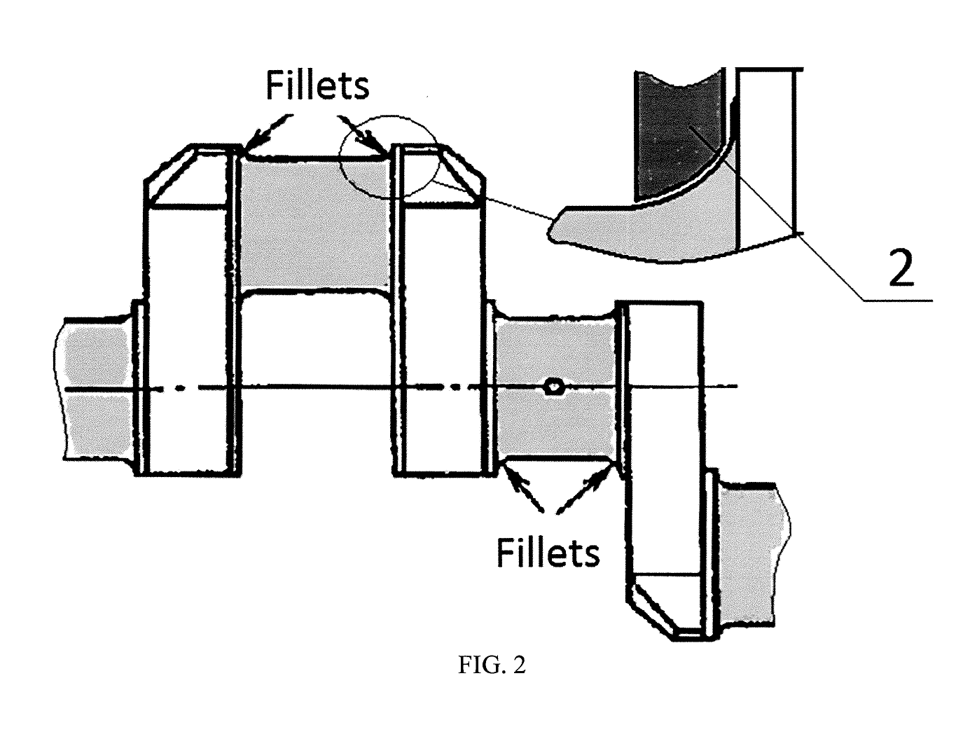

Invention is achieved by placing laser build-up (cladding) nozzle positioning and guidance apparatus directly on the crankshaft journal fillets. These fillets as a rule are not damaged or worn-out and thus holding the original manufacturers dimensions of the crankshaft. Therefore the internal fillets (FIG. 1) or external fillets (FIG. 2) can be used as a reference surface where position the laser cladding nozzle guidance platform, especially guide-ways 2 of the apparatus.

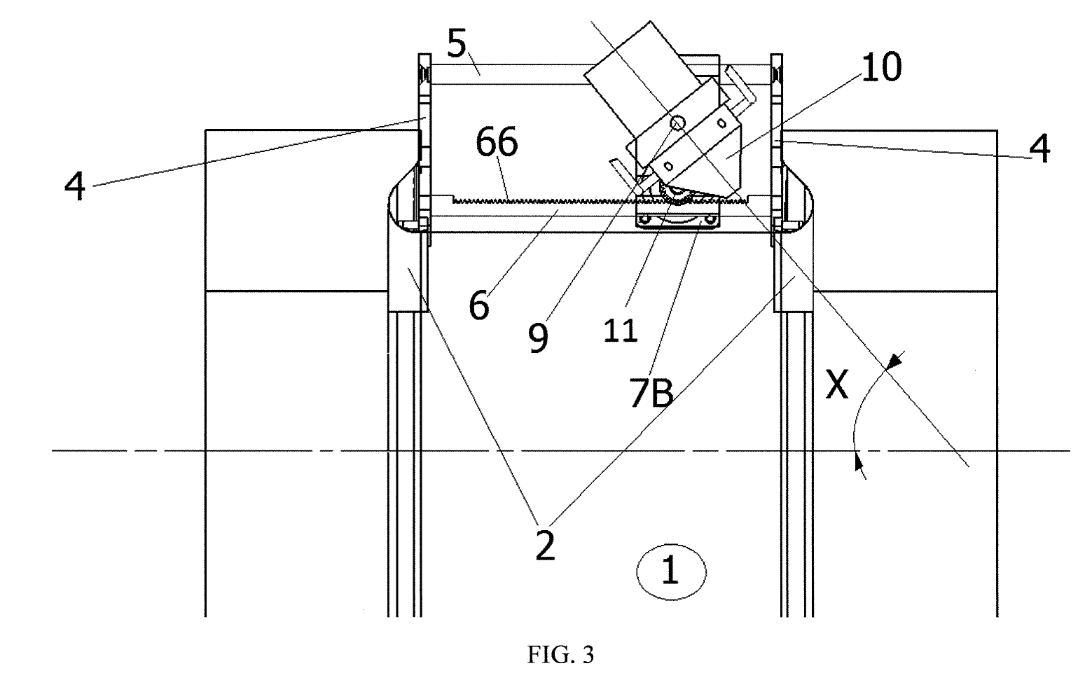

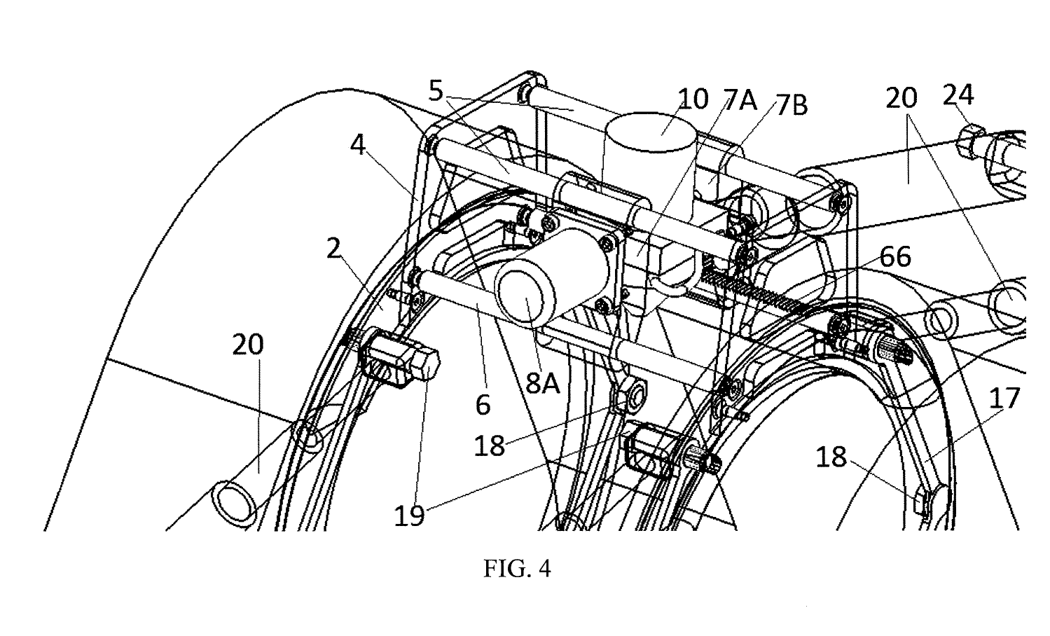

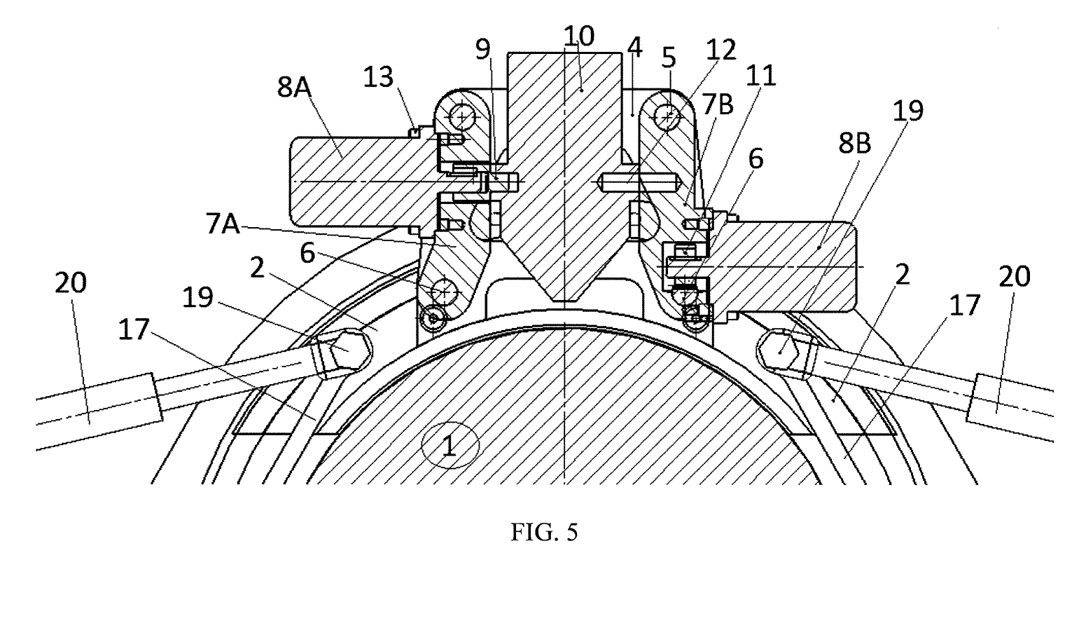

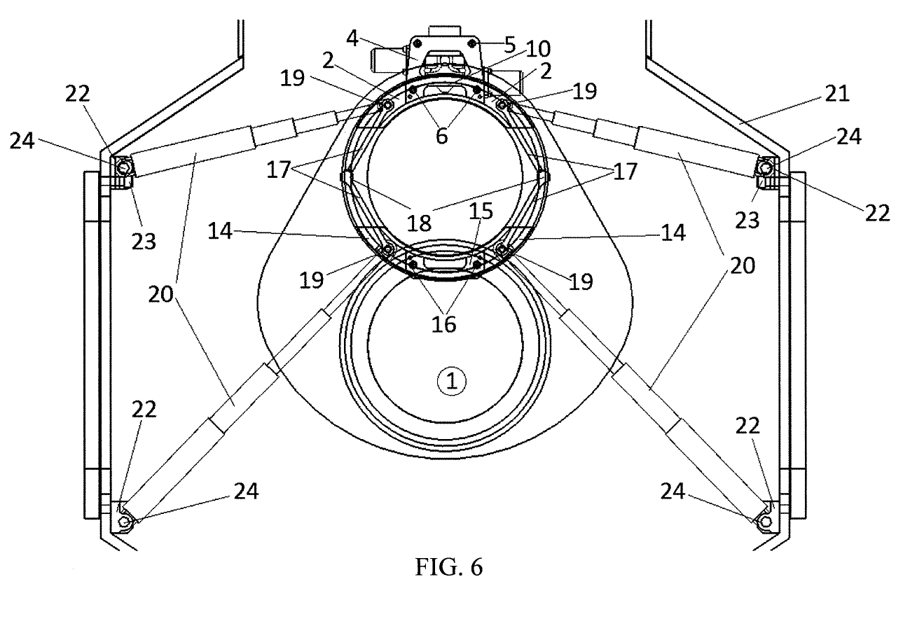

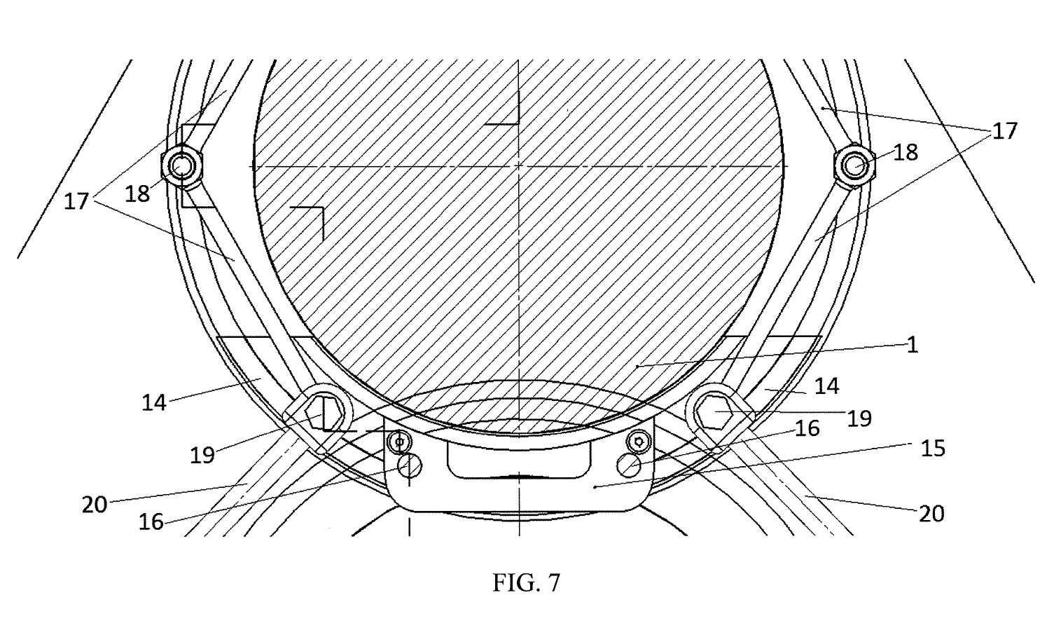

The apparatus (FIG. 3-FIG. 7) is mounted on the crankshaft crankpin 1 journal fillets by means of two sliding guide-ways 2 and two opposite-guide-ways 14. Guide-ways 2 are provided with two frames 4, which are each fixed with two screws (are not showed in the figures). Frames 4 are connected and fixed by means of rods 5 and 6. On the rods 5 and 6 are mounted carriages 7A and 7B allowing longitudinal movement of the carriages 7A and 7B.

Opposite-guide-ways 14 are provided with two supporting plates 15, which are each fixed with two screws (are not showed in the figures). Supporting plates 15 are connected and fixed by means of two opposite-rods 16.

Guide-ways 2 and opposite-guide-ways 14 are placed on the crankshaft journal 1 fillets, and fixed to each other by means of four adjustable arms 17. Angle of the adjustable arms 17 is fixed by the four screws 18. Adjustable arms 17 are connected to the guide-ways 2 and opposite-guide-ways 14 by eight guidance-screws 19.

Crankshaft 1 is being rotated around its main axe, the laser nozzle 10 top-down position is ensured by eight expandable-shrinkable elements 20 (e.g. pneumatic cylinders). These expandable-shrinkable elements 20 are connected with the guide-ways 2 and opposite-guide-ways 14 by the eight guidance-screws 19. Expandable-shrinkable elements 20 are rotating around these eight guidance-screws 19.

Expandable-shrinkable elements 20 are connected to the engine housing 21 with four side-plates 22. These side plates 22 are positioned and fixed on the engine housing 21 service hatches openings bolts 23. Expandable-shrinkable elements 20 are connected to the side-plates 22 by eight guidance-bolts 24. The expandable-shrinkable elements 20 freely rotate around guidance-bolts 24.

Longitudinal feed of the laser nozzle 10 towards crankshaft bearing surface 1 thereto achieved by means of transmission between spur gear 11 and feeding rod—toothed rack 66. Spur gear 11 is fixed on the shaft of a second control motor 8B. Positioning angle or pivoting angle X of the laser nozzle 10 towards the crankpin 1 surface is ensured by a first control motor 8A. Laser nozzle 10 and the first control motor 8A is connected through a bush 9. Laser nozzle 10 is fixed rotatably in carriage 7A by means of a pin 12. Control motors 8A and 8B are secured to the carriages 7A and 7B by means of four fixation screws 13.

During build-up (cladding) operation crankshaft itself is rotated in the engine by built-in means, conventionally by service-electrical motor. This motion is aligned with controlled movements of the control motors 8A and 8B.

The laser build-up (cladding) process includes a step of applying cladding powder or any other cladding material to the damaged surface of the journal. In the same time the cladding powder is irradiated by the high-energy laser beam. Thus a metallurgical bound between crankpin surface and substrate material is achieved by melting both cladding material and substrate. As a result worn-out or damaged surface is restored to its original configuration or to any other desired shape allowing for subsequent mechanical machining.

The following parameters (feeding elements) are synchronised and numerically controlled:
1. Positioning of the second control motor 8B—guiding laser nozzle radial feed;
2. Positioning of the second control motor 8A—guiding laser nozzle angle;
3. Crankshaft rotation frequency;
4. Laser power;
5. Feeding of welding powder.

Laser power lines are flexible as well as cladding powder supply pipes are flexible. They are deployed through piston liner from the top of the engine.

The present invention has been shown and described herein in what is considered to be the most practical and preferred embodiment. It is recognized, however, that departures may be made therefrom within the scope of the invention.

### LIST OF REFERENCE NUMERALS

1—a crankshaft;
2—a guide-way;
4—a frame part;
5—an upper rod;
6—a lower rod;
7A—a first carriage;
7B—a second carriage;
8A—a first control motor;
8B—a second control motor;
9—a bush;
10—a laser nozzle;
11—a spur gear;
12—a pin;
13—a fixation screw;
14—an opposite-guide-way;
15—a supporting plate;
16—an opposite-rod;
17—an adjustable arm;
18—a screw;
19—a guidance-screw;
20—an expandable-shrinkable element;
21—an engine housing;
22—a side plate;
23—a bolt;
24—a guidance-bolt;
66—a toothed rack;
X—a pivoting angle.

1-6. (canceled)

7. Apparatus for repair and renovation of crankshaft journal surfaces, wherein said apparatus comprises:
two guide-ways (2) and two opposite-guide-ways (14) for positioning said apparatus on crankshafts (1) fillets;
two frame parts (4) where each frame part (4) is fixed to a respective guide-way (2);
at least two upper rods (5) by means of which both frame parts (4) are in fixed connection to each other, wherein the upper rods (5) are positioned in the upper part of the frame part (4);
at least two lower rods (6) by means of which both frame parts (4) are in fixed connection to each other, wherein the lower rods (6) are positioned in the lower part of the frame part (4);
two carriages (7A; 7B) which are installed on the upper rods (5) and the lower rods (6) so that the carriages (7A; 7B) can be slidably moved along said rods (5, 6);
a laser nozzle (10) installed on the carriages (7A; 7B);
two control motors (8A; 8B), wherein a first control motor (8A) is installed in the first carriage (7A) and operatively connected to the laser nozzle (10) to control its pivoting angle (X), and a second control motor (8B) is installed in the second carriage (7B) and operatively connected to the one of the two lower rods (6) by means of a gearing transmission to control a longitudinal position of the laser nozzle (10);
two supporting plates (15) where each supporting plate (15) is fixed to a respective opposite-guide-way (14);
at least two opposite-rods (16) by means of which both supporting plates (15) are in fixed connection to each other, wherein the opposite-rods (16) are positioned in the opposite-guide-ways (14);
four adjustable arms (17) by means of which guide-ways (2) and opposite-guide-ways (14) are fixed slidably on the crankshaft journal fillets (1);
at least four screws (18) by means of which angle and position of the adjustable arms (17) is fixed;
at least eight guidance-screws (19) by means of which adjustable arms (17) are connected to the guide-ways (2) and opposite-guide-ways (14); and by means of which also eight expandable-shrinkable elements (2) are rotatably connected to the guide-ways (2) and opposite-guide-ways (14);
at least eight expandable-shrinkable elements (20) by means of which laser nozzle (10) top-down centre position is ensured towards crankshaft fillet (i);
at least four side plates (22), fixed on the engine housing (21) service hatches bolts (23), by means of which expandable-shrinkable elements (20) are connected to the engine housing (21);
at least eight guidance-bolts (24) fixed to the side plates (22) allowing rotatable connection of the expandable-shrinkable elements (20).

8. Apparatus according to claim 7, wherein the gearing transmission comprises a spur gear (11) connected to the second control motor (8B) and a toothed rack (66), which is made directly onto the lower rod (6).

9. Apparatus according to claim 7, wherein the first control motor (8A) is connected to the laser nozzle (10) through a bush (9).

10. Method for repair and renovation of crankshaft journal surfaces using the apparatus according to claim 7, wherein said method includes the steps of:
a) positioning of said apparatus above a damaged surface of the journal by means of said guide-ways (2), opposite-guide-ways (14) and expandable-shrinkable elements (20);
b) rotation of the crankshaft (1) in the engine housing using service motor;
c) applying a cladding powder onto the damaged surface of the journal;
d) positioning of a laser nozzle (10) above the damaged surface of the journal by means of two control motors (8A; 8B);
e) irradiation of the cladding powder by a laser beam emitted from the laser nozzle (10);
f) repeatedly performing steps b) through e) until the damaged surface of the journal is cladded.

11. Method according to claim 10, wherein in step c) a pivoting motion of the laser nozzle (10) is performed by means of the first control motor (8A) and a longitudinal positioning of the laser nozzle (10) is performed by means of the second control motor (8B) and its gearing transmission.

12. Method according to claim 10, wherein top-down positioning of the laser nozzle (10) inside the engine housing is ensured by means of guide-ways (2), opposite-guide-ways (14) and expandable-shrinkable elements (20), ensuring constant cantering of the laser nozzle (10) towards upper centre of rotating crankshaft journal (1).
